(19) United States
(12) Patent Application Publication
(10) Pub. No.: US 2010/0169322 A1
(43) Pub. Date: Jul. 1, 2010

(54) EFFICIENT ACCESS OF BITMAP ARRAY WITH HUGE USAGE VARIANCE ALONG LINEAR FASHION, USING POINTERS

(75) Inventor: Parthasarathy Selvaraj, Bangalore (IN)

Correspondence Address: OSHA LIANG LLP/Oracle, TWO HOUSTON CENTER, 909 FANNIN, SUITE 3500, HOUSTON, TX, 77010, US

(73) Assignee: SUN MICROSYSTEMS, INC., Santa Clara, CA (US)

(21) Appl. No.: 12/344,356

(22) Filed: Dec. 26, 2008

(51) Int. Cl. G06F 17/30; G06F 7/00

(52) U.S. Cl. 707/745; 707/E17.051

(57) ABSTRACT

A system and method for locating an unallocated bit in a bitmap array includes traversing the bitmap array using a plurality of pointers to locate a unit. The unit includes a plurality of entities and at least one of the plurality of entities is unallocated. The method further includes traversing the at least one of the plurality of unallocated entities in the unit to obtain an unallocated entity. The unit is associated with at least one pointer, and the at least one pointer is associated with a plurality of threshold values and a fill count, the fill count being less than a maximum fill count of the bitmap array.

### BACKGROUND

A typical bitmap offers a compact method of representing the state of data or entities used in computing systems. Bitmaps may be used to track entities that have already been allocated (i.e., are in use). The condition of bitmaps may be characterized by the density and distribution of bits of the state indicating the existence of an unallocated entity. Thus, to find an unallocated entity, computing systems must traverse the bitmap to locate an unused entity. The computing system typically traverses the bitmap in O(n) time, where n is the number of allocated entities in the bitmap.

Traditionally, traversing the bitmap involves looping a bitmap until an unallocated entity is found, which can become time consuming when the initial portion of the bitmap is allocated. Specifically, when the initial portion of a bitmap is allocated, multiple lookups are required, which necessitates multiple processing cycles. In fact, the traditional traversal can become even more inefficient when the bitmap is huge, and is filled or cleared in a linear fashion.

### SUMMARY OF INVENTION

In one aspect, embodiments of the present invention relate to a method for locating an unallocated bit in a bitmap array, comprising: traversing the bitmap array using a plurality of pointers to locate a unit, wherein the unit comprises a plurality of entities and at least one of the plurality of entities is unallocated, and traversing the at least one of the plurality of unallocated entities in the unit to obtain an unallocated entity, wherein the unit is associated with at least one pointer, and the at least one pointer is associated with a plurality of threshold values and a fill count, the fill count being less than a maximum fill count of the bitmap array.

In one aspect, embodiments of the present invention relate to a system for locating an unallocated bit, comprising: a bitmap array, wherein the bitmap array comprises a plurality of entities and at least one of the plurality of entities is unallocated; the system configured to: traverse the bitmap array to locate a unit having the at least one unallocated entity, wherein the unit is associated with at least one pointer, and the at least one pointer is associated with a plurality of threshold values and a fill count, the fill count being less than a maximum fill count of the bitmap array.

Other aspects and advantages of the invention will be apparent from the following description and the appended claims. BRIEF DESCRIPTION OF DRAWINGS

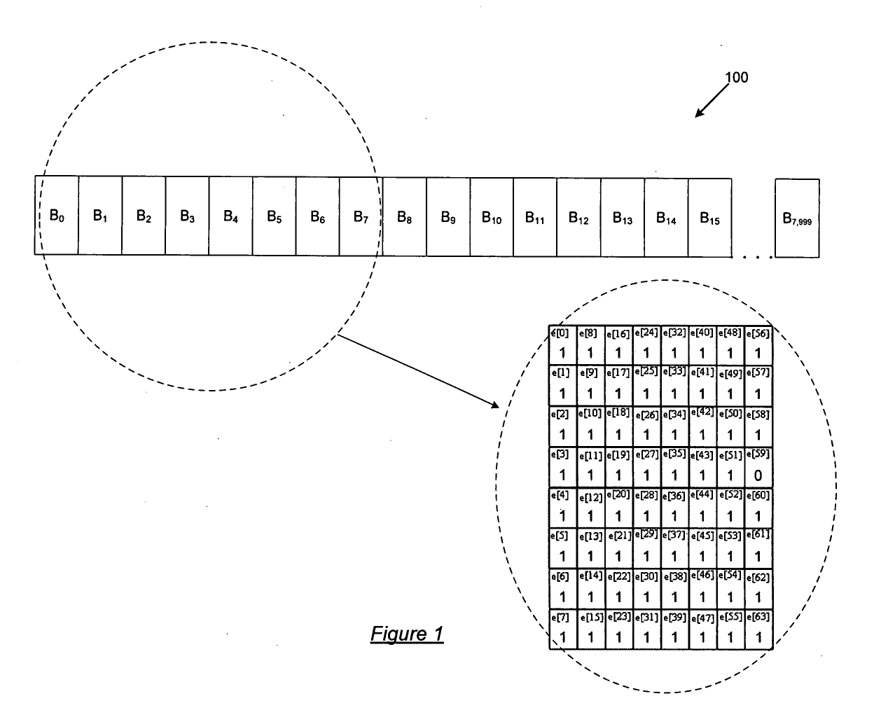

FIG. 1 shows a bitmap array in accordance with one or more embodiments of the claimed invention.

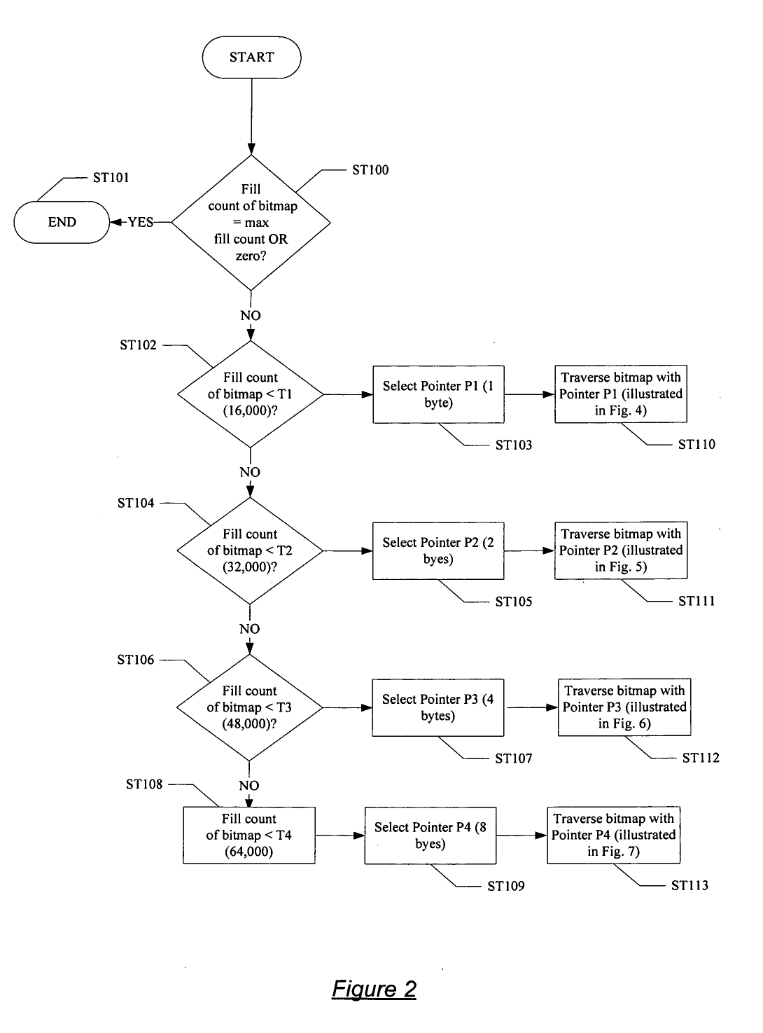

FIG. 2 shows a flowchart in accordance with one or more embodiments of the claimed invention.

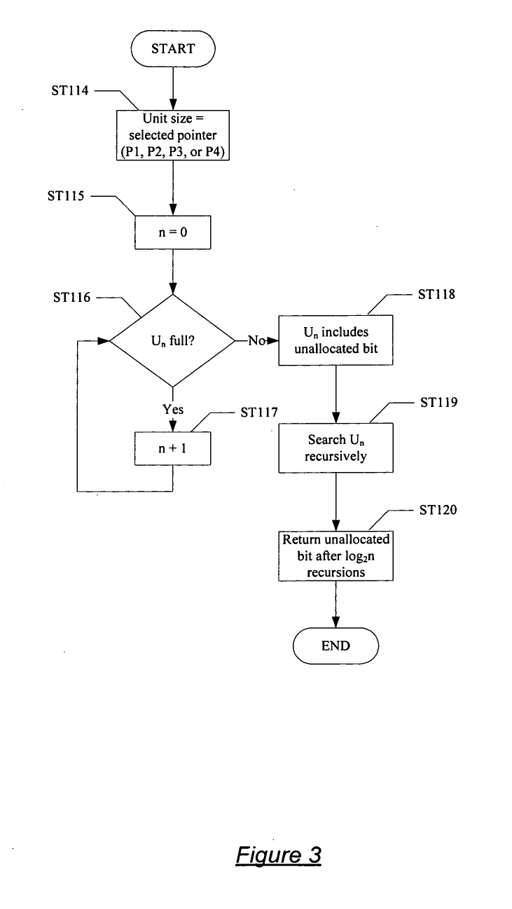

FIG. 3 shows a flowchart in accordance with one or more embodiments of the claimed invention.

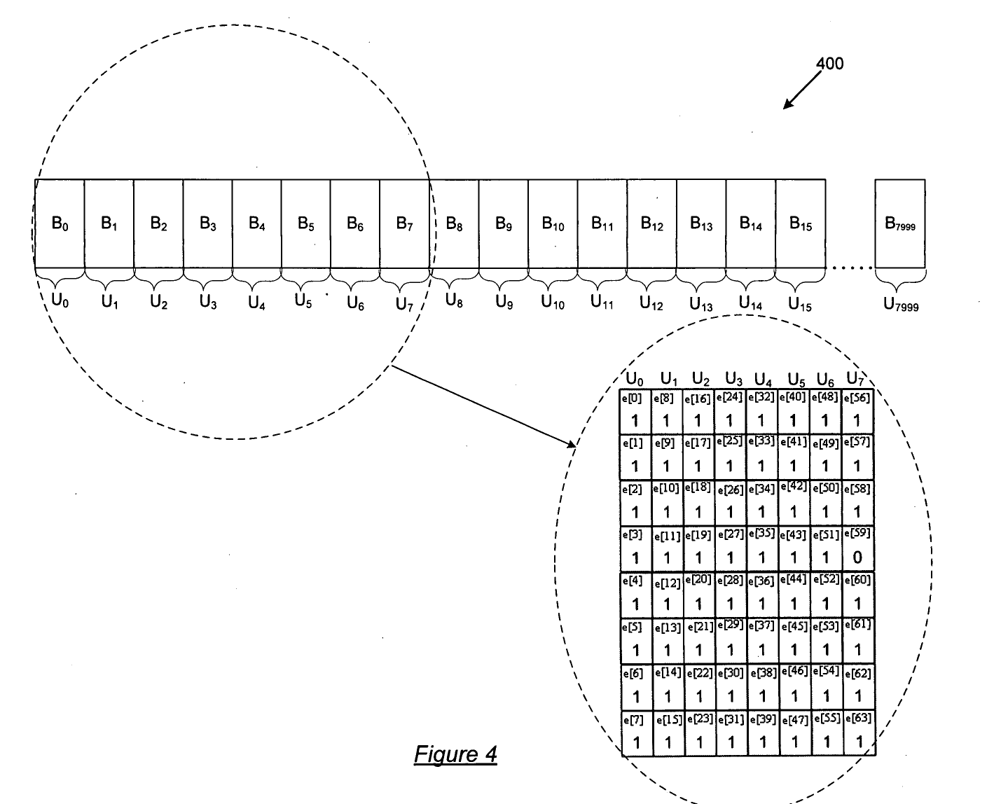

FIG. 4 shows a bitmap array in accordance with one or more embodiments of the claimed invention.

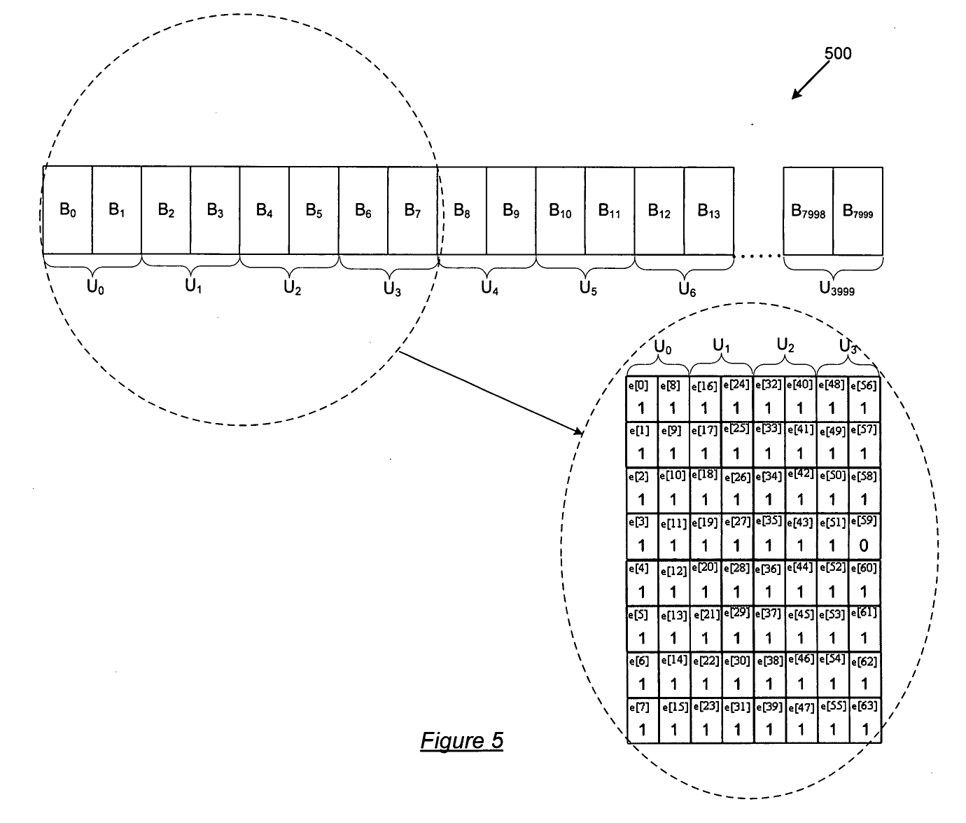

FIG. 5 shows a bitmap array in accordance with one or more embodiments of the claimed invention.

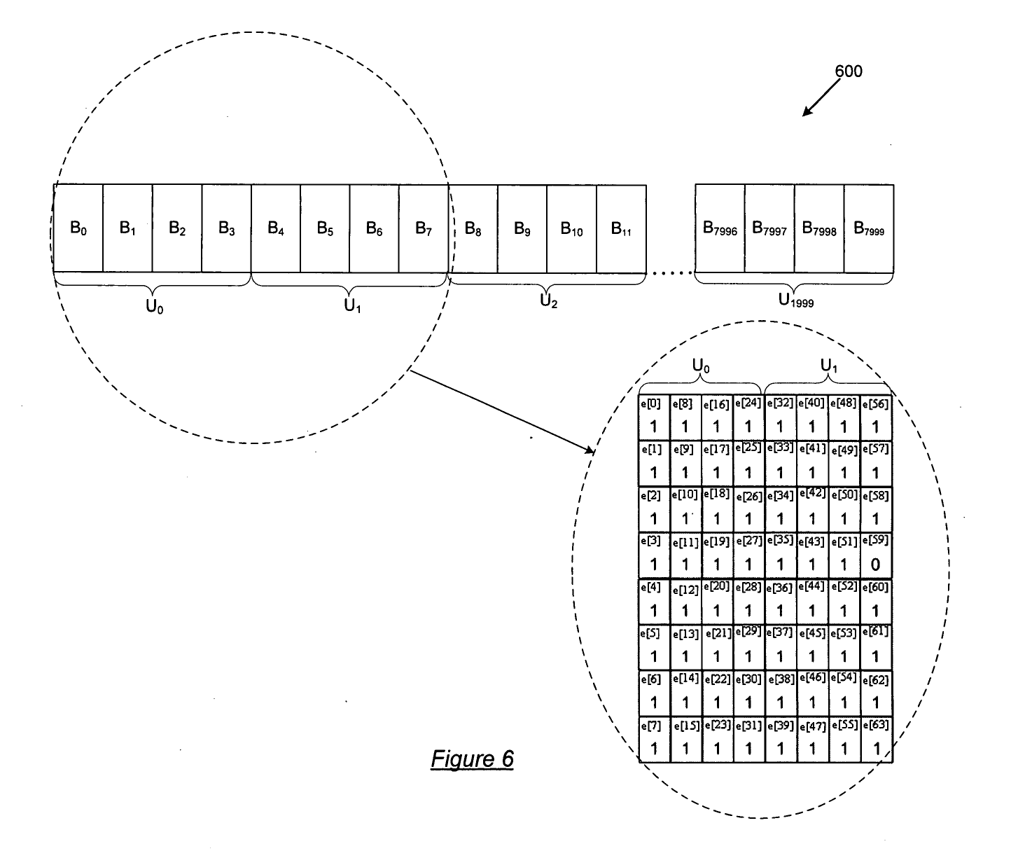

FIG. 6 shows a bitmap array in accordance with one or more embodiments of the claimed invention.

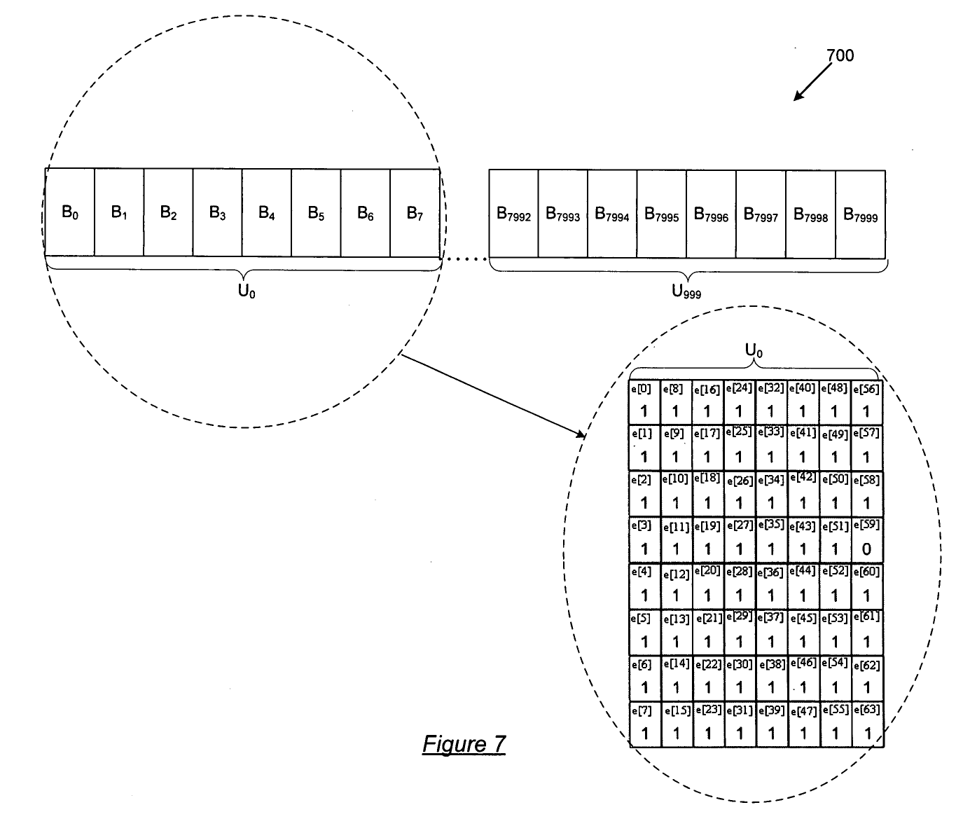

FIG. 7 shows a bitmap array in accordance with one or more embodiments of the claimed invention.

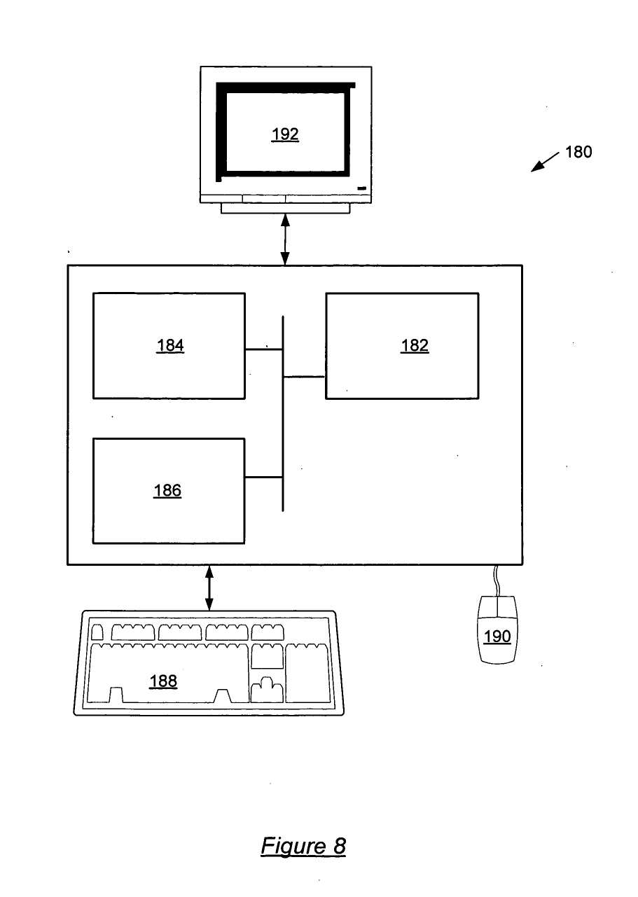

FIG. 8 shows a system in accordance with one or more embodiments of the claimed invention.

### DETAILED DESCRIPTION

Specific embodiments of the invention will now be described in detail with reference to the accompanying figures. Like elements in the various figures are denoted by like reference numerals for consistency.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention relate to a method and system for accessing data. More specifically, embodiments of the invention relate to a method and system for accessing data in a bitmap array using one or more pointers.

FIG. 1 shows a bitmap array 100 in accordance with one or more embodiments of the claimed invention. For example, the bitmap array 100 includes 8,000 bytes, having single-bit entities e₀-e_{63,999}. Thus, the bitmap array 100 of FIG. 1 represents 64,000 entities e₀-e_{63,999}. Although one of ordinary skill in the art will appreciate that bitmap array 100 is not limited to 8,000 bytes, and can include less or more bytes, e.g., sixteen bytes or 15,000 bytes. Of course, those skilled in the art will appreciate that the size of the bitmap array and the size of each entity may vary depending on the particular situation involved. One or more embodiments of the claimed invention provide more efficient results for bitmap arrays, particularly those having a large number of allocated entities.

One of ordinary skill in the art will also appreciate that the bitmap array 100 is a collection of ordered bits in which each bit, whether a “1” or a “0,” gives an indication of, e.g., an allocated/unallocated page in memory or a large number of entity states, such that, each bit represents the entity's usage, and thus, the arrangement of the bits can be any value and in any order. Specifically, in one or more embodiments of the invention, entities e₀-e₇ of B₀ have a value of “11111111”, i.e., 0xFF. A value of 0xFF indicates that every bit corresponding to entities e0-e7 is allocated (flag “1”). Alternatively, in one or more embodiments of the invention, entities e₅₆-e₆₃ of B₇ have a value of “11101111”, i.e., 0xEF. Thus, the value, 0xEF, of B₇ indicates that of the entities e₅₆-e₆₃, one or more entities are unallocated (flag “0”).

In order to locate the unallocated entity, one or more embodiments of the claimed invention uses a pointer to traverse the bitmap array 100 for unallocated entities. A pointer is a programming language data type whose value “points to” another value stored elsewhere in the bitmap array using its address. However, in accordance with one or more embodiments of the claimed invention, the size of the pointer used when traversing the bitmap array 100 depends on the number of entities e₀-e_{63,999} which are allocated. Specifically, once a request to find an unallocated entity in the bitmap array is initiated, a processor (not shown) initiates the method in FIG. 2 to select a pointer size.

Referring now to FIG. 2, initially, a determination is made about whether the fill count of the bitmap array (i.e., allocated entities) is equal to the maximum fill count for the bitmap array or if the fill count of the bitmap array is equal to zero, i.e., all entities are unallocated (ST100). If the fill count for the bitmap array is equal to the maximum fill count or to zero, then there are either no unallocated entities or every entity is unallocated, respectively, and the process ends (ST101). For example, if all 64,000 entities of the bitmap array 100 of FIG. 1 are allocated, then the bitmap array 100 has reached its maximum fill count, and a need to search for unallocated entities is no longer necessary. One of ordinary skill in the art will appreciate that the above example would only occur in an error scenario.

Alternatively, if the fill count for the bitmap array is not equal to the maximum fill count or zero, then there are one or more unallocated entities, e.g., unallocated pages in memory, and the process proceeds to ST102.

Because the size of the pointer used to traverse the bitmap array depends on the fill count, one or more embodiments of the claimed invention may use a series of threshold values in conjunction with the fill count to determine an appropriate pointer size. The threshold values may be predetermined, based on the size of the bitmap array being traversed. For example, the embodiment shown in FIG. 2 relies on four different threshold values {T1, T2, T3, T4} that are predetermined in accordance with the bitmap array 100 of FIG. 1. Specifically, because bitmap array 100 represents 64,000 entities, predetermined threshold values T1, T2, T3, and T4 may correspond to values {16000, 32000, 48000, 64000}, respectively. Although the predetermined threshold values {T1, T2, T3, T4} represent four values equidistant from each other, one of ordinary skill in the art will appreciate that any number of threshold values may be used corresponding to any value less than the total number of bits in the bitmap array.

Referring now to ST102 in FIG. 2, a determination is made about whether the fill count of the bitmap array is less than predetermined threshold value T1 (16,000). If the fill count for the bitmap array is less than predetermined threshold value T1 (16,000), then the process continues to ST103 for pointer selection. Alternatively, if the fill count for the bitmap array is not less than 16,000, i.e., greater than 16,000, the process continues to ST104. In ST104, a determination is made about whether the fill count of the bitmap array is less than predetermined threshold value T2 (32,000). If the fill count for the bitmap array is less than predetermined threshold value T2 (32,000), then the process continues to ST105 for pointer selection. Alternatively, if the fill count for the bitmap array is not less than 32,000, i.e., greater than 32,000, the process continues to ST106. In ST106, a determination is made as to whether the fill count of the bitmap array is less than predetermined threshold value T3 (48,000). If the fill count for the bitmap array is less than predetermined threshold value T3 (48,000), then the process continues to ST107 for pointer selection. Alternatively, if the fill count for the bitmap array is not less than 48,000, i.e., greater than 48,000, the process continues to ST108. In ST108, the fill count of the bitmap array is less than predetermined threshold value T4 (64,000), and thus, the process continues to ST109 for pointer selection.

As discussed previously, the size of the pointer used to traverse the bitmap array depends on the fill count in conjunction with the predetermined threshold value. Thus, in one or more embodiments of the claimed invention, a series of pointers are used to traverse the bitmap array, dependent on where the fill count value falls in comparison to the predetermined threshold values {T1, T2, T3, T4}. For example, as shown in FIG. 2, because there are four predetermined threshold values T1, T2, T3, T4}, four corresponding pointer sizes {P1, P2, P3, P4} are used to traverse the bitmap array, respectively. In this example, pointers {P1, P2, P3, P4} correspond to the following pointer sizes: one byte, two bytes, four bytes, and eight bytes, respectively. One of ordinary skill in the art will appreciate, however, that although the aforementioned pointer sizes were selected in relation to a bitmap array having 64,000 bits, one or more pointer sizes may be selected from a variety of different lengths, depending on the entity usage of the bitmap array. Further, one of ordinary skill in the art will appreciate that pointer sizes will vary when used in conjunction with bitmap arrays having bits less than or greater than 64,000 bits.

Thus, pointer P1 of size one byte is selected in ST110 (illustrated in FIG. 4), pointer P2 of size two bytes is selected in ST111 (illustrated in FIG. 5), pointer P3 of size four bytes is selected in ST112 (illustrated in FIG. 6), and pointer P4 of size eight bytes is selected in ST113 (illustrated in FIG. 7).

Alternatively, pointer sizes may depend on predetermined threshold values that are maintained at irregular levels, e.g., one or more embodiments may maintain threshold values at {8000, 16000, 32000, 64000} or {800, 8000, 16000, 64000}. Specifically, the threshold values depend on the entities usage pattern. Thus, even if two different bitmap arrays had the same number of entities, the threshold values may be different, depending on the entities usage pattern.

For example, one or more embodiments may maintain threshold value T4 as the maximum number of entities in the bitmap array. Thus, if a one byte pointer is always desired, then threshold values could be equal to the following: T1=T2=T3=T4=64,000. In this case, the sequence in FIG. 2 will always be ST100, ST102, ST103, ST110. In one or more embodiments, this type of sequence may be beneficial for systems which have a minimum number of bitmap entities.

Similarly, if a system always desires to use the eight byte pointer, one or more embodiments could maintain threshold values in accordance with the following: T1=T2=T3=0 and T4=64,000. In this embodiment, the sequence in FIG. 2 will always be ST108, ST109, ST113. In one or more embodiments, this type of sequence may be beneficial for systems which have a large number of entities, with less variance (low/slow allocation/deallocation). One of ordinary skill in the art will appreciate that a similar method may be used when desiring only two or four byte pointers.

Alternatively, in one or more embodiments, the threshold values may instead be updated depending upon the system bitmap usage pattern, once every time (t) units, where ‘t’ depends on system characteristics. In these embodiments, if the system is a real time system, ‘t’ could be a bigger value, and in normal systems, this could be a small value.

Referring still to FIG. 2, once a pointer size is selected in at least one of steps (ST103, ST105, ST107, or ST109) of FIG. 2, a traversal of the bitmap array initiates the method in FIG. 3 to locate an unallocated entity for pointer sizes {one byte, two bytes, four bytes, eight bytes}, illustrated by FIGS. 4, 5, 6, and 7, respectively. Referring now to FIG. 3, each unit size is set to the size of the selected pointer. A unit denotes the number of consecutive entities that can be accessed by the pointer. Beginning with unit U₀, a determination is made whether the entities contained within unit U₀ are entirely allocated (each single-bit entity in the unit is flagged “1”) (ST115 and ST116).

If unit U₀ is entirely allocated, the traversal will continue to the next unit until a unit is found which is not entirely allocated (ST117 and ST118). In this situation, the particular unit that includes at least one unallocated entity is recursively searched (ST119). One of ordinary skill in the art will appreciate that the size of each unit reflects on the number of recursion calls which will be required by the traversal (ST120). Specifically, in one or more embodiments of the claimed invention, the unallocated entities are obtained by evaluating log₂ n, where n is equal to the number of entities contained in a unit. However, one of ordinary skill in the art will appreciate that recursively searching the unit is only an example of one embodiment of the claimed invention, and many other methods known in the art for searching a particular unit may be used.

Referring now to FIG. 4, a bitmap array 400 utilizing a one byte pointer is shown, in accordance with one or more embodiments of the claimed invention. As discussed previously with reference to FIG. 2, pointer P1 of size one byte is selected when the number of entities allocated in the bitmap array is less than the predetermined threshold value T1 (16,000). For example, in this embodiment, the number of entities allocated in the bitmap array may be equal to 4,000 or 8,000. The bitmap array 400 includes 8,000 bytes, having single-bit entities e₀-e_{63,999}. Thus, the bitmap array 400 of FIG. 4 represents 64,000 entities e₀-e_{63,999}. Although, one of ordinary skill in the art will appreciate that bitmap array 400 is not limited to 8,000 bytes, and can include less or more bytes, e.g., sixteen bytes or 15,000 bytes. One or more embodiments of the claimed invention provide more efficient results for bitmap arrays, particularly those having a large number of allocated entities.

FIG. 4 will now be described in relation to the method shown in FIG. 3, such that, in one or more embodiments of the invention, the traversal of the bitmap array attempts to locate an unallocated bit in the bitmap array, where the traversal uses pointers to determine (i) whether a particular unit in the bitmap array includes an unallocated bit and (ii) which entity in the particular unit of the bitmap array is unallocated. Because the selected pointer in FIG. 4 is one byte, each unit U₀-U₇₉₉₉ in the bitmap array 400 is equal to one byte (ST114). Thus, the bitmap array 400 is divided into 8000 units, such that, eight consecutive bits can be accessed by the pointer P1 at a time.

Referring still to FIGS. 3 and 4, beginning with unit U₀, a determination is made whether the entities contained within unit U₀ are entirely allocated (each single-bit entity in the unit is flagged “1”) (ST115 and ST116). Thus, because unit U₀ is entirely allocated, i.e., entities e₀-e₇=“11111111” or 0xFF, the traversal will continue to the next unit until a unit is found which is not entirely allocated (ST116 and ST117). In this embodiment, units U₀-U₆ are each found to contain a value of 0xFF, i.e., each unit U₀-U₆ is entirely allocated. However, when pointer P1 accesses unit U₇, the traversal will discover that the value of unit U₇ is not equal to 0xFF, i.e., one or more unallocated entities exist in unit U₇ (one or more entities e₅₆-e₆₃ is unallocated (flag “0”)) (ST118).

As shown in ST119, the traversal will now search unit U₇ recursively for the unallocated entities (ST119). One of ordinary skill in the art will appreciate that the size of each unit reflects on the number of recursion calls which will be required by the traversal (ST120). Specifically, in one or more embodiments of the claimed invention, the unallocated entities may be obtained by evaluating log₂ n, where n is equal to the number of single-bit entities contained in a unit. Unit U₇ will require a total number of three recursive calls to return the location of the unallocated bit (log₂(8)=3). One of ordinary skill in the art will appreciate that recursively searching the unit is only one example of an embodiment of the claimed invention, and many other methods known in the art for searching a particular unit may be used.

Thus, because the size of the selected pointer was set equal to one byte, eight pointer checks and three recursive calls were necessary to find the unallocated bit. One of ordinary skill in the art will appreciate that a pointer of size two bytes may be used for the same size bitmap array, as shown in FIG. 5.

Referring now to FIG. 5, a bitmap array 500 utilizing a two byte pointer is shown, in accordance with one or more embodiments of the claimed invention. As discussed previously with reference to FIG. 2, pointer P2 of size two bytes is selected when the number of entities allocated in the bitmap array is less than the predetermined threshold value T2 (32,000) and greater than the predetermined threshold value T1 (16,000). For example, in this embodiment, the number of entities allocated in the bitmap array may be equal to 17,000 or 28,000. The bitmap array 500 includes 8,000 bytes, having single-bit entities e₀-e_{63,999}. Thus, the bitmap array 500 of FIG. 5 represents 64,000 entities e₀-e_{63,999}. Although one of ordinary skill in the art will appreciate that bitmap array 500 is not limited to 8,000 bytes, and can include less or more bytes, e.g., sixteen bytes or 15,000 bytes, the embodiments of the claimed invention provide more efficient results for bitmap arrays that have a large number of allocated entities.

FIG. 5 will now be described in relation to the method shown in FIG. 3, such that, in one embodiment of the invention, the traversal of the bitmap array attempts to locate an unallocated bit in the bitmap array, where the traversal uses pointers to determine (i) whether a particular unit in the bitmap array includes an unallocated bit and (ii) which entity in the particular unit of the bitmap array is unallocated. Because the selected pointer in FIG. 5 is two bytes, each unit U₀-U₃₉₉₉ in the bitmap array 500 is equal to two bytes (ST114). Thus, the bitmap array 500 is divided into 4000 units, such that, sixteen consecutive bits can be accessed by the pointer P2 at a time.

Referring still to FIGS. 3 and 5, beginning with unit U₀, a determination is made as to whether the entities contained within unit U₀ are entirely allocated (each single-bit entity in the unit is flagged “1”) (ST115 and ST116). Thus, because unit U₀ is entirely allocated, i.e., entities e₀-e₁₅=“1111111111111111” or 0xFFFF, the traversal will continue to the next unit until a unit is found which is not entirely allocated (ST116 and ST117). In this embodiment, units U₀-U₂ are each found to contain a value of 0xFFFF, i.e., each unit U₀-U₂ is entirely allocated. However, when pointer P2 accesses unit U₃, the traversal will discover that the value of unit U₃ is not equal to 0xFFFF, i.e., one or more unallocated entities exist in unit U₃ (one or more entities e₄₈-e₆₃ is unallocated (flag “0”)) (ST118).

As shown in ST119, the traversal will search unit U₃ recursively for the unallocated entity (ST119). One of ordinary skill in the art will appreciate that the size of each unit reflects on the number of recursion calls which will be required by the traversal (ST120). Specifically, in one or more embodiments of the claimed invention, the unallocated entities may be obtained by evaluating log₂ n, where n is equal to the number of single-bit entities contained in a unit. Thus, unit U₃ will require a total number of four recursive calls to return the location of the unallocated bit (log₂(16)=4). One of ordinary skill in the art will appreciate that recursively searching the unit is only one example of an embodiment of the claimed invention, and many other methods known in the art for searching a particular unit may be used.

Thus, because the size of the selected pointer was set equal to two bytes, four pointer checks and four recursive calls were necessary to find the unallocated bit. One of ordinary skill in the art will appreciate that a pointer of size four bytes may also be used for the same size bitmap array, as shown in FIG. 6.

Referring now to FIG. 6, a bitmap array 600 utilizing a four byte pointer is shown, in accordance with one or more embodiments of the claimed invention. As discussed previously with reference to FIG. 2, pointer P3 of size four bytes is selected when the number of entities allocated in the bitmap array is less than the predetermined threshold value T3 (48,000) and greater than the predetermined threshold value T2 (32,000). For example, in this embodiment, the number of entities allocated in the bitmap array may be equal to 36,000 or 42,000. The bitmap array 600 includes 8,000 bytes, having single-bit entities e₀-e_{63,999}. Thus, the bitmap array 600 of FIG. 6 represents 64,000 entities e₀-e_{63,999}. Although one of ordinary skill in the art will appreciate that bitmap array 600 is not limited to 8,000 bytes, and can include less or more bytes, e.g., sixteen bytes or 15,000 bytes. Thus, one or more embodiments of the claimed invention provide more efficient results for bitmap arrays, particularly those have a large number of allocated entities.

FIG. 6 will now be described in relation to the method shown in FIG. 3, such that, in one or more embodiments of the invention, the traversal of the bitmap array attempts to locate an unallocated bit in the bitmap array, where the traversal uses pointers to determine (i) whether a particular unit in the bitmap array includes an unallocated bit and (ii) which entity in the particular unit of the bitmap array is unallocated. Because the selected pointer in FIG. 6 is four bytes, each unit U₀-U₁₉₉₉ in the bitmap array 600 is equal to four bytes (ST114). Thus, the bitmap array 600 is divided into 2000 units, such that, thirty-two consecutive bits can be accessed by the pointer P3 at a time.

Referring still to FIGS. 3 and 6, beginning with unit U₀, a determination is made whether the entities contained within unit U₀ are entirely allocated (each single-bit entity in the unit is flagged “1”) (ST115 and ST116). Thus, because unit U₀ is entirely allocated, i.e., entities e₀-e₃₁=“11111111111111111111111111111111” or 0xFFFFFFFF, the traversal will continue to the next unit until a unit is found which is not entirely allocated (ST116 and ST117). In this embodiment, when pointer P3 accesses unit U₁, the traversal will discover that the value of unit U₁ is not equal to 0xFFFFFFFF, i.e., one or more unallocated entities exist in unit U₁ (one or more entities e₃₂-e₆₃ is unallocated (flag “0”)) (ST118).

As shown in ST119, the traversal will now search unit U₁ recursively for the unallocated entity (ST119). One of ordinary skill in the art will appreciate that the size of each unit reflects on the number of recursion calls which will be required by the traversal (ST120). Specifically, in one or more embodiments of the claimed invention, the unallocated entities may be obtained by evaluating log₂ n, where n is equal to the number of single-bit entities contained in a unit. Thus, unit U₁ will require a total number of five recursive calls to return the location of the unallocated bit (log₂(32)=5). One of ordinary skill in the art will appreciate that recursively searching the unit with the unallocated bit is only one example, and any means known in the art for searching a particular unit may be used.

Thus, because the size of the selected pointer was set equal to four bytes, two pointer checks and five recursive calls were necessary to find the unallocated bit. One of ordinary skill in the art will appreciate that a pointer of size eight bytes may also be used for the same size bitmap array, as shown in FIG. 7.

Referring now to FIG. 7, a bitmap array 700 utilizing an eight byte pointer is shown, in accordance with one or more embodiments of the claimed invention. As discussed previously with reference to FIG. 2, pointer P4 of size eight bytes is selected because the number of entities allocated in the bitmap array is less than the predetermined threshold value T4 (64,000) and greater than the predetermined threshold value T3 (48,000). For example, in this embodiment, the number of entities allocated in the bitmap array may be equal to 56,000 or 60,000. The bitmap array 700 includes 8,000 bytes, having single-bit entities e₀-e_{63,999}. Thus, the bitmap array 700 of FIG. 7 represents 64,000 entities e₀-e_{63,999}. Although one of ordinary skill in the art will appreciate that bitmap array 700 is not limited to 8,000 bytes, and can include less or more bytes, e.g., sixteen bytes or 15,000 bytes. Thus, one or more embodiments of the claimed invention provide more efficient results for bitmap arrays, particularly those that are large.

FIG. 7 will now be described in relation to the method shown in FIG. 3, such that, in one or more embodiments of the invention, the traversal of the bitmap array attempts to locate an unallocated bit in the bitmap array, where the traversal uses pointers to determine (i) whether a particular unit in the bitmap array includes an unallocated bit and (ii) which entity in the particular unit of the bitmap array is unallocated. Because the selected pointer in FIG. 7 is eight bytes, each unit U₀-U₉₉₉ in the bitmap array 700 is equal to eight bytes (ST114). Thus, the bitmap array 700 is divided into 1000 units, such that, sixty-four consecutive bits can be accessed by the pointer P4 at a time.

Referring still to FIGS. 3 and 7, beginning with unit U₀, a determination is made whether the entities contained within unit U₀ are entirely allocated (each single-bit entity in the unit is flagged “1”) (ST115 and ST116). In this embodiment, because unit U₀ is not entirely allocated, i.e., entities e₀-e₆₃≠“1111111111111111111111111111111111111111111111111111111111111111” or 0xFFFFFFFFFFFFFFFF, the traversal will discover that one or more unallocated entities exist in unit U₀ (one or more entities e₀-e₆₃ is unallocated (flag “0”)) (ST118).

As shown in ST119, the traversal will now search unit U₀ recursively for the unallocated entity (ST119). One of ordinary skill in the art will appreciate that the size of each unit reflects on the number of recursion calls which will be required by the traversal (ST120). Specifically, in one or more embodiments of the claimed invention, the unallocated entities may be obtained by evaluating log₂ n, where n is equal to the number of single-bit entities contained in a unit. Thus, unit U₀ will require a total number of six recursive calls to return the location of the unallocated bit (log₂(64)=6). One of ordinary skill in the art will appreciate that recursively searching the unit with the unallocated bit is only one example, and any means known in the art for searching a particular unit may be used. Thus, because the size of the selected pointer was set equal to eight bytes, one pointer check and six recursive calls were necessary to find the unallocated bit. Further, one of ordinary skill in the art will also appreciate, as illustrated in FIGS. 4-7, increasing the pointer size decreases the number of pointer checks required, and increases the number of recursion calls.

The claimed invention may be implemented on virtually any type of computer regardless of the platform being used. For example, as shown in FIG. 8 a networked computer system (180) includes a processor (182), associated memory (184), a storage device (186), and numerous other elements and functionalities typical of today's computers (not shown). The networked computer system (180) may also include input means, such as a keyboard (188) and a mouse (190), and output means, such as a monitor (192). The networked computer system (180) is connected to a local area network (LAN) or a wide area network (e.g., the Internet) (not shown) via a network interface connection (not shown). Those skilled in the art will appreciate that these input and output means may take other forms. Further, those skilled in the art will appreciate that one or more elements of the aforementioned computer (180) may be located at a remote location and connected to the other elements over a network. In one embodiment of the invention, the node corresponds to a computer system. Alternatively, the node may correspond to a processor with associated physical memory.

Further, software instructions to perform embodiments of the invention may be stored on a computer readable medium such as a compact disc (CD), a diskette, a tape, a file, or any other computer readable storage device.

Those skilled in the art will appreciate that numerous applications of the disclosed embodiments may be devised without departing from the scope of the invention. For example, in one or more embodiments of the present invention, the bitmap array may represent a shared memory. When multiple processes run simultaneously, these processes may share the same common public memory (RAM) space, i.e., the shared memory. Thus, when process “A” wants to communicate with process “B,” process “A” traverses the shared memory (bitmap array), for a free location to write a message into the shared memory. Meanwhile, process “B” constantly polls the shared memory to see if it has any new messages. When process “B” finds the message from process “A,” it reads and interprets the message, and then clears the message from the shared memory.

Those skilled in the art will appreciate that numerous variations of the disclosed embodiments may be devised without departing from the scope of the invention. In one or more embodiments of the present invention, a bitmap array may include two-bit entities instead of single-bit entities.

One or more embodiments of the present invention may include one or more of the following advantages. The method for traversing a bitmap array, disclosed in one or more embodiments of the claimed invention, may allow for improved efficiency when searching for unallocated bits. Specifically, one or more embodiments of the claimed invention may reduce the number of pointer checks or recursive calls needed to traverse a bitmap array.

While the present invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A method for locating at least one unallocated bit in a bitmap array, comprising:
traversing the bitmap array using a plurality of pointers to locate a unit, wherein the unit comprises a plurality of entities and at least one of the plurality of entities is unallocated, and
traversing the at least one of the plurality of unallocated entities in the unit to obtain an unallocated entity,
wherein the unit is associated with at least one pointer, and the at least one pointer is associated with a plurality of threshold values and a fill count, the fill count being less than a maximum fill count of the bitmap array.

2. The method of claim 1, wherein the threshold values are predetermined.

3. The method of claim 1, wherein the threshold values are updated based on entity usage.

4. The method of claim 1, wherein traversing the at least one of the plurality of unallocated entities in the unit to obtain an unallocated entity comprises,
recursively searching the unit.

5. The method of claim 1, wherein bit lengths of the plurality of the pointers are less than the bitmap array length.

6. The method of claim 1, wherein the fill count is a non-negative integer.

7. The method of claim 1, wherein the fill count corresponds to a number of allocated entities in the bitmap array.

8. The method of claim 1, wherein the allocated entity references usage of a location in memory.

9. The method of claim 1, wherein at least one pointer from the plurality of pointers is one selected from the group consisting of: one byte, two bytes, four bytes, and eight bytes.

10. The method of claim 1, wherein bit length of each entity from the plurality of entities is equal to at least one bit.

11. A system for locating unallocated bits, comprising:
a bitmap array, wherein the bitmap array comprises a plurality of entities and at least one of the plurality of entities is unallocated;
the system configured to:
traverse the bitmap array to locate a unit having the at least one unallocated entity,
wherein the unit is associated with at least one pointer, and the at least one pointer is associated with a plurality of threshold values and a fill count, the fill count being less than a maximum fill count of the bitmap array.

12. The system of claim 11, wherein the threshold values are predetermined.

13. The system of claim 11, wherein the threshold values are updated based on entity usage.

14. The system of claim 11, wherein traversing the at least one of the plurality of unallocated entities in the unit to obtain an unallocated entity comprises,
recursively searching the unit.

15. The system of claim 11, wherein bit lengths of the plurality of the pointers are less than the bitmap array length.

16. The system of claim 11, wherein the fill count is a non-negative integer.

17. The system of claim 11, wherein the fill count corresponds to a number of allocated entities in the bitmap array.

18. The method of claim 11, wherein the allocated entity references usage of a location in memory.

19. The method of claim 11, wherein at least one pointer from the plurality of pointers is one selected from the group consisting of: one byte, two bytes, four bytes, and eight bytes.

20. The method of claim 11, wherein bit length of each entity from the plurality of entities is equal to at least one bit.
